(19) United States
(12) Patent Application Publication
(10) Pub. No.: US 2026/0204608 A1
(43) Pub. Date: Jul. 16, 2026

(54) ELECTROLYTE MEMBRANE FOR HIGH-TEMPERATURE POLYMER ELECTROLYTE MEMBRANE FUEL CELL

(71) Applicants: Hyundai Motor Company, Seoul (KR); Kia Corporation, Seoul (KR); INDUSTRY-ACADEMIC COOPERATION FOUNDATION GYEONGSANG NATIONAL UNIVERSITY, Jinju-si, Gyeongsangnam-do (KR)

(72) Inventors: Won Jae Choi, Hwaseong-si (KR); So Hwa Kim, Hwaseong-si (KR); Songi Oh, Hwaseong-si (KR); Da Hee Kwak, Hwaseong-si (KR); Sung Hee Shin, Hwaseong-si (KR); Jee Youn Hwang, Hwaseong-si (KR); Ah Hyeon Park, Hwaseong-si (KR); Ki Hyun Kim, Yongin-si (KR); Soon Sik Hwang, Geoje-si (KR); Seo Yeong Jeong, Sacheon-si (KR); Hye Min Hwang, Busan (KR)

(73) Assignees: Hyundai Motor Company, Seoul (KR); KIA Corporation, Seoul (KR); INDUSTRY-ACADEMIC COOPERATION FOUNDATION GYEONGSANG NATIONAL UNIVERSITY, Jinju-si, Gyeongsangnam-do (KR)

(21) Appl. No.: 19/249,866

(22) Filed: Jun. 25, 2025

(30) Foreign Application Priority Data
Jan. 15, 2025 (KR) 10-2025-0005932

(51) Int. Cl. H01M 8/1067; H01M 8/10; H01M 8/1027; H01M 8/103; H01M 8/1034; H01M 8/1039; H01M 8/1072

(52) U.S. Cl. CPC H01M 8/1067; H01M 8/1027; H01M 8/103; H01M 8/1034; H01M 8/1039; H01M 8/1072; H01M 2008/1095; H01M 2300/0082

(57) ABSTRACT

Disclosed are an electrolyte membrane for a high-temperature polymer electrolyte membrane fuel cell including a polymer electrolyte having a novel structure with an ether group introduced therein, and a method of manufacturing the same.

### CROSS-REFERENCE TO RELATED APPLICATION

This application claims, under 35 U.S.C. § 119(a), the benefit of priority from Korean Patent Application No. 10-2025-0005932, filed on Jan. 15, 2025, the entire contents of which are incorporated herein by reference.

### TECHNICAL FIELD

The present disclosure relates to an electrolyte membrane for a high-temperature polymer electrolyte membrane fuel cell including a polymer electrolyte having a novel structure with an ether group introduced therein, and a method of manufacturing the same.

### BACKGROUND

A proton exchange membrane (PEM) plays a key role in the operation of polymer electrolyte membrane fuel cells (PEMFCs), acting as a selective barrier that facilitates the transport of protons, while inhibiting the passage of other ions and gases. The efficacy of a PEM is typically determined by its proton conductivity, which directly influences fuel cell performance. High degrees of hydration in PEMs significantly enhance proton conductivity; however, excessive water uptake can lead to dimensional instability, compromising the mechanical integrity of the membrane.

High-temperature polymer electrolyte membrane fuel cells (HT-PEMFCs) utilize phosphoric acid-doped membranes, which fundamentally differ from their low-temperature counterparts. The incorporation of phosphoric acid not only enhances proton conduction but also provides a more stable performance across a wider temperature range, typically from 120° C. up to 200° C. This elevation in temperature allows for improved electrode kinetics, resulting in faster reaction rates and higher power outputs compared to traditional polymer electrolyte membranes.

The benefits of HT-PEMFCs extend beyond improved kinetics and simplified operation. Their enhanced impurity tolerance opens avenues for using a broader range of fuels, making them suitable for various applications, including those in energy generation. Also, the durability of phosphoric acid fuel cells can be linked to these advantages, potentially leading to longer service life and lower maintenance costs.

One of the most widely utilized PEMs, Nafion, is perfluorinated and has a level of chemical stability and conductivity. Despite these advantages, Nafion's high cost, methanol permeability, and limited operational temperature range (typically around 80° C.) present notable challenges for practical applications. In contrast, polybenzimidazole (PBI) has emerged as a notable alternative for high-temperature polymer electrolyte membrane fuel cells, as it maintains high physicochemical stability in harsher environments. Nevertheless, PBI's application is hindered by lower energy efficiency and the risk of poisoning due to phosphoric acid leakage, which poses concerns regarding the operational integrity and longevity of the fuel cells. Thus, there is a need to develop alternative membrane materials that can retain high conductivity while providing improved physicochemical stability, lower production costs, and mass manufacturability.

### SUMMARY

In embodiments, disclosed herein is an electrolyte membrane for a high-temperature polymer electrolyte membrane fuel cell having a high molecular weight and excellent physical stability, and a method of manufacturing the same.

In embodiments, disclosed herein is an electrolyte membrane for a high-temperature polymer electrolyte membrane fuel cell having good flexibility and excellent thermal stability by virtue of an ether group introduced therein, and a method of manufacturing the same.

In embodiments, disclosed herein is an electrolyte membrane for a high-temperature polymer electrolyte membrane fuel cell with low phosphoric acid leakage, and a method of manufacturing the same.

In embodiments, disclosed herein is an electrolyte membrane for a high-temperature polymer electrolyte membrane fuel cell that is easy to mass produce, and a method of manufacturing the same.

Various embodiments are not limited to the foregoing. Various embodiments will be able to be clearly understood through the following description and to be realized by the means described in the claims and combinations thereof.

In embodiments, disclosed herein is an electrolyte membrane for a high-temperature polymer electrolyte membrane fuel cell, including a polymer electrolyte having proton conductivity, in which the polymer electrolyte includes a main chain including one or more of fluorene or diphenyl ether and a side chain including a nitrogen-including functional group.

The nitrogen-including functional group may include a quaternary ammonium cation.

The side chain may further include a proton conductive functional group connected to the nitrogen-including functional group.

The proton conductive functional group may include a dihydrogen phosphate anion (H₂PO₄⁻).

The nitrogen-including functional group and the proton conductive functional group may be connected by electrostatic attraction.

The polymer electrolyte may be represented by Chemical Formula 1 below.

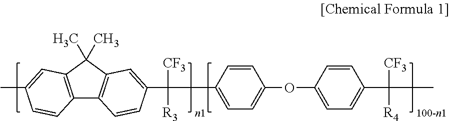

In Chemical Formula 1, each of R₁, R₂, R₃, and R₄ may include hydrogen, an alkyl group having 1 to 3 carbon atoms, or —(CH₂)ₓ—R₅·H₂PO₄⁻ (where x is a number ranging from 1 to 6), at least one selected from among R₁, R₂, R₃, and R₄ may include —(CH₂)ₓ—R₅·H₂PO₄⁻ (where x is a number from 1 to 6), R₅ may include —R₆R₇R₈N⁺, each of R₆, R₇, and R₈ may include an alkyl group having 1 to 3 carbon atoms; or two thereof may be connected to each other to form a ring having 2 to 6 carbon atoms and the remaining one may include an alkyl group having 1 to 3 carbon atoms, and n1 may be a number ranging from 10 to 90.

In Chemical Formula 1, at least two selected from among R₁, R₂, R₃, and R₄ may include —(CH₂)ₓ—R₅·H₂PO₄⁻ (where x is a number ranging from 1 to 6).

The polymer electrolyte may be represented by Chemical Formula 2 below.

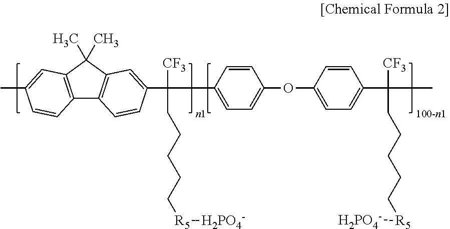

In Chemical Formula 2, R₅ may include —R₆R₇R₈N⁺, each of R₆, R₇, and R₈ may include an alkyl group having 1 to 3 carbon atoms; or two thereof may be connected to each other to form a ring having 2 to 6 carbon atoms and the remaining one may include an alkyl group having 1 to 3 carbon atoms, and n2 may be a number ranging from 10 to 90.

The polymer electrolyte may have a 5 wt % weight loss temperature of less than 350° C. as measured by thermogravimetric analysis (TGA).

The polymer electrolyte may have a glass transition temperature of 160° C. or less.

The electrolyte membrane may have an elongation at break of 80% or more and a Young's modulus of 200 MPa or less.

In embodiments, disclosed herein is a method of manufacturing an electrolyte membrane for a high-temperature polymer electrolyte membrane fuel cell, including preparing an intermediate material represented by Chemical Formula 3 below by condensation polymerization of a fluorene monomer and a diphenyl ether monomer in the presence of an acid catalyst, preparing a polymer electrolyte represented by Chemical Formula 4 below by reacting the intermediate material with an amine compound, manufacturing a thin film using the polymer electrolyte, and manufacturing an electrolyte membrane by impregnating the thin film with phosphoric acid.

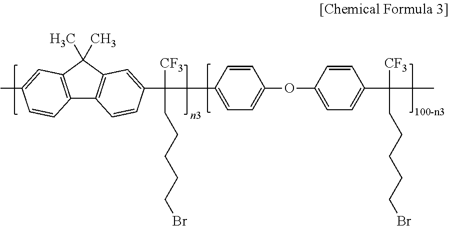

In Chemical Formula 3, n3 may be a number ranging from 10 to 90.

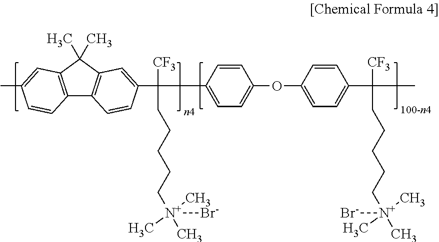

In Chemical Formula 4, n4 may be a number ranging from 10 to 90.

Preparing the intermediate material may include performing the condensation polymerization at 15° C. to 25° C. for 30 minutes or less.

### BRIEF DESCRIPTION OF THE DRAWINGS

The above and other features of the present disclosure will now be described in detail with reference to certain various embodiments thereof illustrated in the accompanying drawings which are given hereinbelow by way of illustration only, and thus are not limitative of the present disclosure, and wherein:

FIG. 1 shows a high-temperature polymer electrolyte membrane fuel cell.

FIG. 2 shows results of ¹H-NMR of an intermediate material according to Preparation Example.

FIG. 3 shows results of ¹H-NMR of a polymer precursor used in a polymer electrolyte membrane according to Preparation Example.

FIG. 4 shows results of analyzing Preparation Example and Comparative Preparation Example using Fourier transform infrared (FT-IR) spectroscopy.

FIG. 5 is an enlarged view of a specific area of FIG. 4.

FIG. 6 shows results of thermogravimetric analysis (TGA) of Preparation Example and Comparative Preparation Example.

FIG. 7 shows results of differential scanning calorimetry (DSC) of Preparation Example and Comparative Preparation Example.

FIG. 8 shows a strain-stress curve for a specimen before and after doping with phosphoric acid in Example.

### DETAILED DESCRIPTION

The above and other objects, features and advantages of the present disclosure will be more clearly understood from the following various embodiments taken in conjunction with the accompanying drawings. However, the present disclosure is not limited to various embodiments disclosed herein, and may be modified into different forms. Various embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

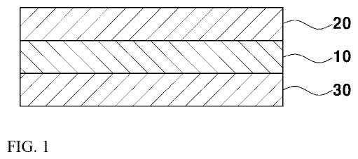

FIG. 1 shows a high-temperature polymer electrolyte membrane fuel cell according to the present disclosure.

The high-temperature polymer electrolyte membrane fuel cell may be a polymer electrolyte membrane fuel cell that operates at a high temperature of about 120° C. to 200° C. Alternatively, the high-temperature polymer electrolyte membrane fuel cell may be a polymer electrolyte membrane fuel cell that operates at a relative humidity of about 50% or less.

The high-temperature polymer electrolyte membrane fuel cell has the same structure or principle as a conventional low-temperature polymer electrolyte membrane fuel cell, but has advantages such as no water flooding at the anode and no need for a humidification system.

The high-temperature polymer electrolyte membrane fuel cell may include an electrolyte membrane 10, an anode 20 disposed on one surface of the electrolyte membrane 10, and a cathode 30 disposed on the remaining surface of the electrolyte membrane 10.

The electrolyte membrane 10, the anode 20, and the cathode 30 are not limited in shape, thickness, area, etc., and those commonly used in the technical field to which the present disclosure pertains may be applied.

The electrolyte membrane 10 may include a polymer electrolyte having proton conductivity. The proton conductivity may indicate the ability to conduct or exchange protons (H⁺) to move between the anode 20 and the cathode 30.

The polymer electrolyte may include a main chain and a side chain connected to the main chain.

The main chain may include at least one of fluorene or diphenyl ether. The main chain may include fluorene and diphenyl ether.

Since fluorene has a large free volume, which is the space between atoms, introduction of fluorene to the main chain is able to lower the extent of increase in crystallinity when polymerizing the polymer electrolyte, thereby increasing the molecular weight of the polymer electrolyte. Physical stability of the electrolyte membrane 10 may be increased.

In addition, since fluorene has a large free volume, the polymer electrolyte has high solubility in an aprotic solvent. An electrolyte membrane 10 may be easily manufactured using the polymer electrolyte.

Diphenyl ether contains an ether group, which may impart flexibility to the polymer electrolyte and increase thermal stability of the polymer electrolyte. In addition, the ether group has an electron donating effect during polymerization, making it possible to synthesize the polymer electrolyte in a short time.

The side chain may include a nitrogen-including functional group. The nitrogen-including functional group may include a quaternary ammonium cation. For example, the quaternary ammonium cation may be one in which any one hydrogen in an ammonium cation (NH₄⁺) is a connecting site and all remaining hydrogens are replaced with methyl groups (—CH₃).

The side chain may further include a linker connecting the nitrogen-including functional group to the main chain. The linker is not particularly limited and may include, for example, a substituted or unsubstituted alkyl group having 1 to 6 carbon atoms.

When the polymer electrolyte is impregnated with phosphoric acid, the side chain may further include a proton conductive functional group connected to the nitrogen-including functional group. The proton conductive functional group may include a dihydrogen phosphate anion (H₂PO₄⁻).

The polymer electrolyte is characterized by including an ion-pair structure in which the proton conductive functional group is connected to the nitrogen-including functional group. The mutual attraction of the ion-pair structure may be maintained higher than that of a conventional phosphoric acid-doped polybenzimidazole-based polymer, thus solving the problem of phosphoric acid leakage at high temperatures.

The polymer electrolyte may include a compound represented by Chemical Formula 1 below.

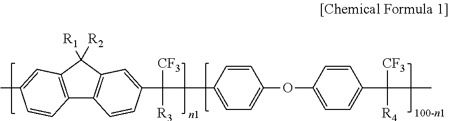

In Chemical Formula 1, each of R₁, R₂, R₃, and R₄ may include hydrogen, an alkyl group having 1 to 3 carbon atoms, or —(CH₂)ₓ—R₅·H₂PO₄⁻ (where x is a number ranging from 1 to 6), and at least one selected from among R₁, R₂, R₃, and R₄ may include —(CH₂)ₓ—R₅·H₂PO₄⁻ (where x is a number ranging from 1 to 6). Here, “·” may represent the electrostatic attraction between R₅ and dihydrogen phosphate anion (H₂PO₄⁻).

Here, R₅ may include —R₆R₇R₈N⁺, in which each of R₆, R₇, and R₈ may include an alkyl group having 1 to 3 carbon atoms; or two thereof may be connected to each other to form a ring having 2 to 6 carbon atoms and the remaining one may include an alkyl group having 1 to 3 carbon atoms.

R₅ may include

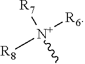

R₅ may include

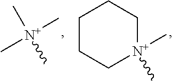

etc. Here, [symbol] may represent a connecting site.

n1 may be a number ranging from 10 to 90.

Various embodiments of the polymer electrolyte are one in which at least two selected from among R₁, R₂, R₃, and R₄ include —(CH₂)ₓ—R₅·H₂PO₄⁻ (where x is a number ranging from 1 to 6).

Various embodiments of the polymer electrolyte may include a compound represented by Chemical Formula 2 below.

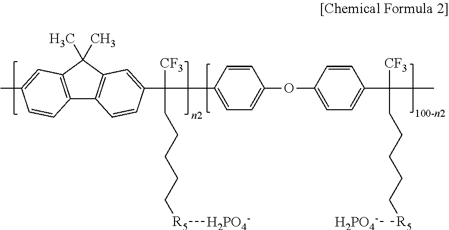

In Chemical Formula 2, R₅ may include —R₆R₇R₈N⁺, in which each of R₆, R₇, and R₈ may include an alkyl group having 1 to 3 carbon atoms; or two thereof may be connected to each other to form a ring having 2 to 6 carbon atoms and the remaining one may include an alkyl group having 1 to 3 carbon atoms. In Chemical Formula 2, “------” may represent the electrostatic attraction between R₅ and dihydrogen phosphate anion (H₂PO₄⁻). Here, n2 may be a number ranging from 10 to 90.

A method of manufacturing the electrolyte membrane 10 may include preparing an intermediate material represented by Chemical Formula 3 below by condensation polymerization of a starting material including a fluorene monomer and a diphenyl ether monomer in the presence of an acid catalyst, preparing a polymer electrolyte represented by Chemical Formula 4 below by reacting the intermediate material with an amine compound, manufacturing a thin film using the polymer electrolyte, and manufacturing an electrolyte membrane by impregnating the thin film with phosphoric acid.

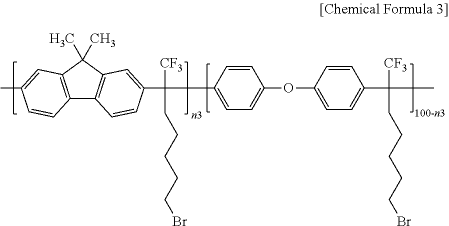

In Chemical Formula 3 n3 may be a number ranging from 10 to 90.

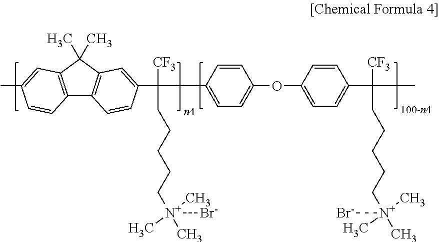

In Chemical Formula 4, n4 may be a number ranging from 10 to 90.

The fluorene monomer is not particularly limited and may include, for example, 9,9-dimethylfluorene. The diphenyl ether monomer is not particularly limited and may include, for example, diphenyl ether. Since the fluorene monomer and the diphenyl ether monomer are relatively easy to obtain, the method of manufacturing an electrolyte membrane according to the present disclosure may be suitable for mass production.

The starting material may further include a brominated compound such as 7-bromo-1,1,1-trifluoroheptan-2-one, etc.

The acid catalyst is not particularly limited and may include, for example, trifluoromethanesulfonic acid, etc.

Preparing the intermediate material may include condensation reaction at 15° C. to 25° C. for 30 minutes or less. According to the present disclosure, a polymer electrolyte may be manufactured within a short period of time at room temperature.

By reacting the intermediate material with an amine compound such as trimethylamine, a polymer electrolyte with a nitrogen-including functional group introduced into the side chain may be obtained.

The electrolyte membrane may be manufactured by dissolving the polymer electrolyte in a solvent, manufacturing the thin film by a process such as casting, and then impregnating the thin film with phosphoric acid.

The anode 20 and cathode 30 may each include a catalyst and an ionomer.

The catalyst may include any material commonly used in the technical field to which the present disclosure pertains. For example, the catalyst may include a precious metal catalyst such as platinum (Pt), a non-precious metal catalyst, or an alloy catalyst thereof.

The ionomer may include any material commonly used in the technical field to which the present disclosure pertains. For example, the ionomer may include a phosphoric acid-doped polybenzimidazole-based polymer or the same polymer electrolyte as in the electrolyte membrane 10 described above.

A better understanding of the present disclosure may be obtained through the following preparation examples and example. The following preparation examples and example are merely set forth to illustrate the present disclosure and are not to be construed as limiting the scope of the present disclosure.

### PREPARATION EXAMPLE

A starting material represented by Chemical Formula 3-1 below was synthesized by the following method. Diphenyl ether (0.61 g, 3.58 mmol), 9,9-dimethylfluorene (1.62 g, 8.36 mmol), and 7-bromo-1,1,1-trifluoroheptan-2-one (3.24 g, 13.14 mmol) were prepared as monomers. Trifluoromethanesulfonic acid (TFSA) (12.55 g, 83.62 mmol) was prepared as a catalyst. 13.5 parts by weight of dichloromethane (DCM) as a reaction solvent was prepared based on 100 parts by weight of monomers, and 100 parts by weight of the monomers and the catalyst were added to the reaction solvent to prepare a reactant. The reactant was reacted for about 30 minutes, synthesizing an intermediate material represented by Chemical Formula 3-1 below. The intermediate material was precipitated in 1,300 ml of methanol, washed several times with methanol, and dried in a vacuum oven at about 40° C.

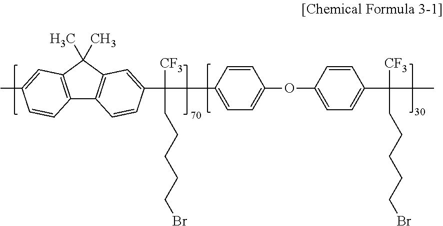

Using the intermediate material, a polymer electrolyte represented by Chemical Formula 4-1 below was synthesized. 100 parts by weight of the intermediate material (2 g, 4.80 mmol) and trimethylamine (0.99 g, 16.82 mmol) were dissolved in 10 parts by weight of dimethylacetamide (DMAc), followed by reaction at about 15° C. to 25° C. for about 24 hours, obtaining a polymer electrolyte. The polymer electrolyte was precipitated in 500 ml of tetrahydrofuran (THF), washed several times with acetone, and dried in a vacuum oven at about 60° C.

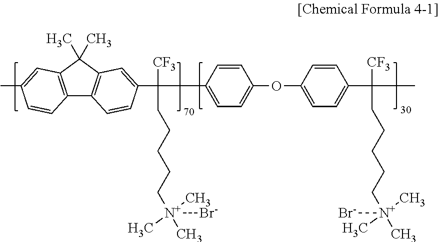

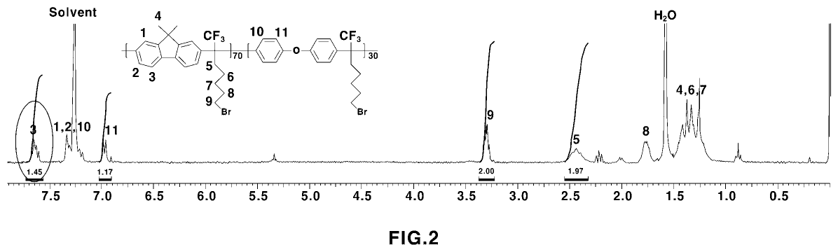

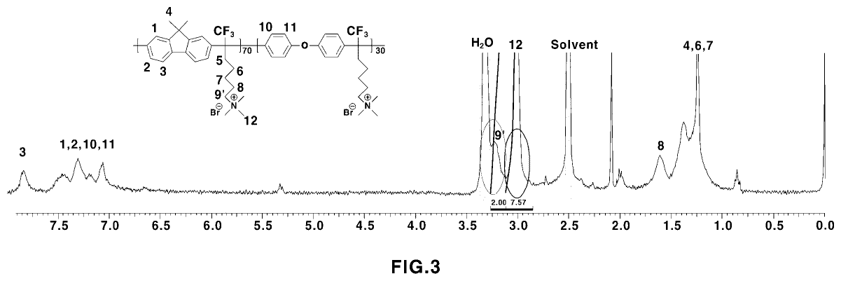

FIG. 2 shows results of ¹H-NMR of the intermediate material according to Preparation Example. FIG. 3 shows results of ¹H-NMR of the polymer electrolyte according to Preparation Example. In FIG. 2, the progress of reaction may be determined through a change in the NMR peak of CH₂ (9) next to the terminal modifiable position (—Br) of the intermediate material. Referring to FIG. 3, it can be found that the intermediate material was synthesized into a polymer electrolyte at a conversion of 100% as peak 9 of FIG. 2 shifted and changed to peak 9′, thereby generating peak 12.

### COMPARATIVE PREPARATION EXAMPLE

A polymer electrolyte was manufactured in the same manner as in Preparation Example, with the exception that diphenyl ether among the monomers in Preparation Example was changed to biphenyl. The polymer electrolyte according to Comparative Preparation Example is represented by Chemical Formula 5 below.

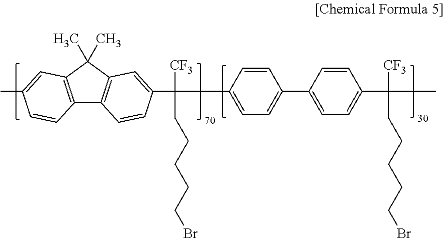

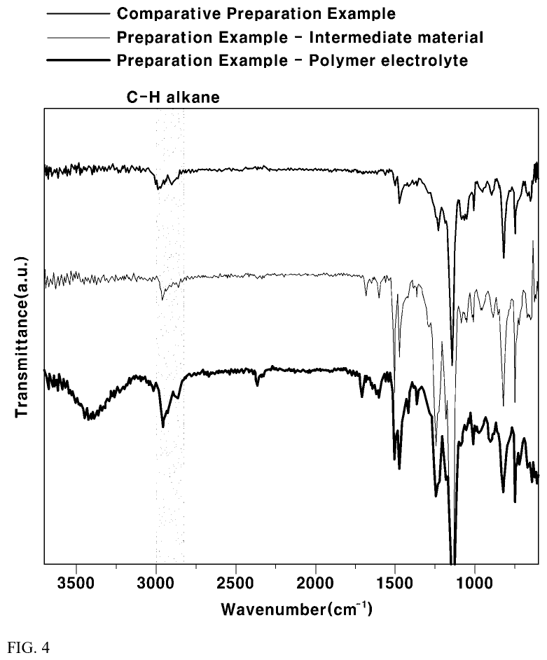

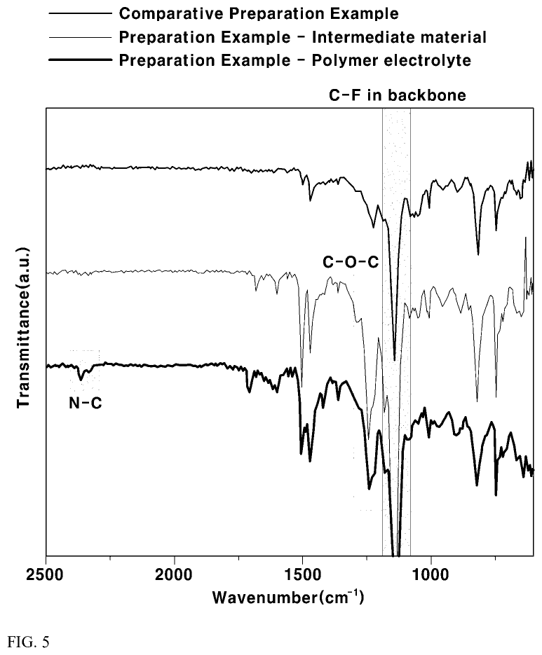

FIG. 4 shows results of analyzing Preparation Example and Comparative Preparation Example using Fourier transform infrared (FT-IR) spectroscopy. FIG. 5 is an enlarged view of a specific area of FIG. 4. Fourier transform infrared spectroscopy is a widely used analytical technique to determine the molecular structure and chemical properties of a material. Analysis was performed by infrared irradiation of a sample and information about the infrared absorption of the molecules in the sample at specific wavelengths. Referring to FIG. 4 and FIG. 5, a C—H peak was observed around 3000 to 2840 cm⁻¹, a C—O—C peak around 1240 cm⁻¹ and a C—F peak around 1400 to 1000 cm⁻¹ were found. Meanwhile, in Preparation Example, an N—C peak was found around 2322 to 2138 cm⁻¹, based on which the change in the terminal functional group can be confirmed.

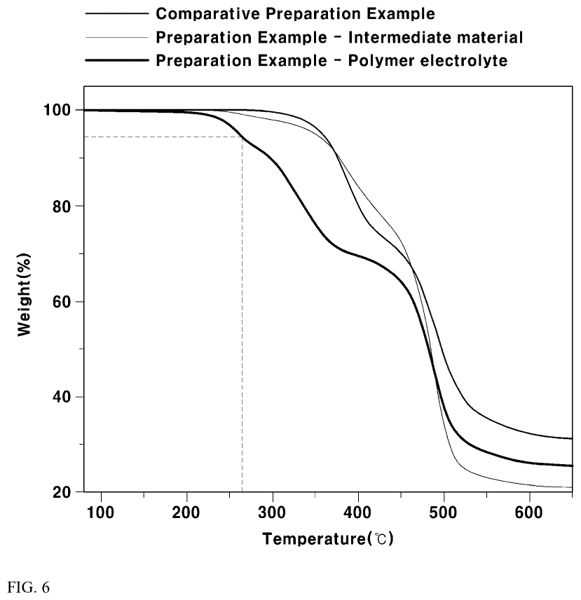

FIG. 6 shows results of thermogravimetric analysis (TGA) of Preparation Example and Comparative Preparation Example. Each sample was heated from room temperature to about 120° C. at a rate of about 20° C./min and kept for about 10 minutes to remove residual moisture. Thereafter, the sample was cooled to about 60° C. at a rate of about 20° C./min, then heated to about 650° C. at a rate of about 10° C./min under a nitrogen atmosphere, and the weight change of the sample was measured. The 5 wt % weight loss temperature of each sample is shown in Table 1 below.

TABLE 1

| | Comparative | Preparation | Preparation |
|---|---|---|---|
| | Preparation | Example- | Example- |
| Items | Example | Intermediate material | Polymer electrolyte |
| T_{d5} [° C.] | 357 | 350 | 260 |

The polymer electrolyte according to the present disclosure had a 5 wt % weight loss temperature of less than 350° C., particularly about 260° C., as measured by thermogravimetric analysis (TGA). Thus, the polymer electrolyte according to the present disclosure has excellent thermal stability.

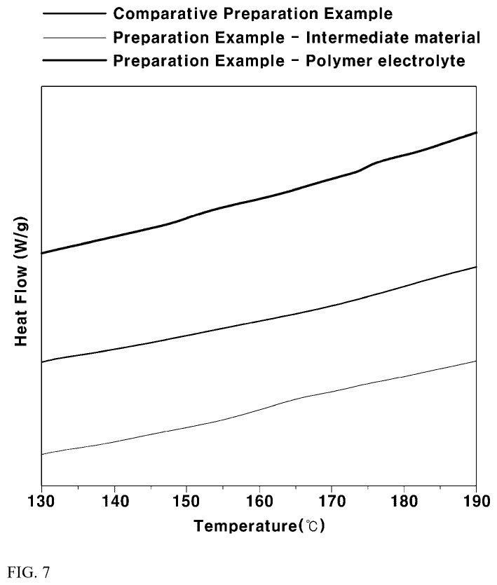

FIG. 7 shows results of differential scanning calorimetry (DSC) of Preparation Example and Comparative Preparation Example. Each sample was heated from room temperature to about 200° C. at a rate of about 20° C./min and maintained for about 1 minute. Thereafter, the sample was cooled to about −20° C. at a rate of about 20° C./min and then maintained for about 10 minutes to stabilize the same. Subsequently, the glass transition temperature of each sample was measured under a nitrogen atmosphere during heating to about 200° C. at a rate of about 20° C./min and cooling to about −20° C. at a rate of about 20° C./min. The results thereof are shown in Table 2 below.

TABLE 2

| | Comparative | Preparation | Preparation |
|---|---|---|---|
| | Preparation | Example- | Example- |
| Items | Example | Intermediate material | Polymer electrolyte |
| T_{g} [° C.] | 182 | 161 | 151 |

The polymer electrolyte according to the present disclosure had a glass transition temperature of 160° C. or less, particularly about 151° C. and thus exhibited thermal stability sufficient to be used in a high-temperature polymer electrolyte membrane fuel cell.

### EXAMPLE

A thin film was manufactured in a manner in which the polymer electrolyte according to Preparation Example was dissolved in dimethyl sulfoxide (DMSO), cast into a frame made of 8 mm×8 mm aluminum tape, and dried in an oven at about 60° C. for about 24 hours. The thin film was separated and then dried at room temperature for about 24 hours. An electrolyte membrane was manufactured by impregnating the thin film with an about 85 wt % aqueous phosphoric acid solution at about 120° C. for about 22 hours.

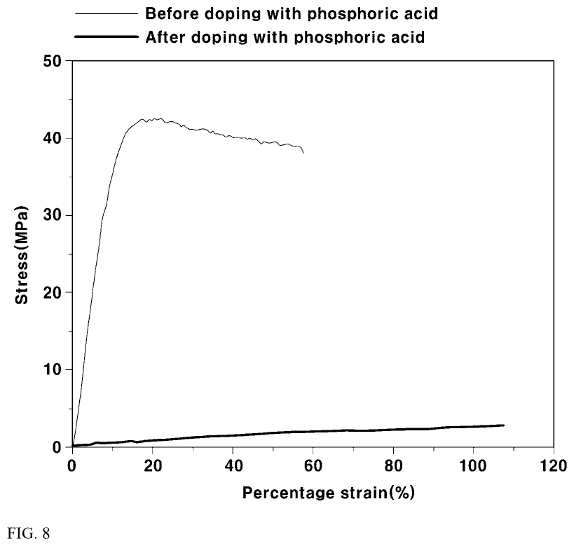

FIG. 8 shows a strain-stress curve for a specimen before and after doping with phosphoric acid in Example. The mechanical properties of each specimen are shown in Table 3 below. After attaching a 250 N load cell to the LLOYD UTM LS1 device, each cut specimen according to ASTM D 638 type V was fastened. The extension rate was set to 5 mm/min. Five measurements were performed for each specimen, and the average and standard deviation of the strain-stress curve, Young's modulus, and elongation thereof were determined.

TABLE 3

| | Tensile | Young’s | Elongation |
|---|---|---|---|
| | strength | modulus | at break |
| Classification | [MPa] | [Pa] | [%] |
| Before doping with | 40.78 ± 2.73 | 781.66 ± 105.55 | 39.65 ± 14.27 |
| phosphoric acid | | | |
| After doping with | 2.47 ± 0.26 | 159.37 ± 221.55 | 86.4 ± 17.06 |
| phosphoric acid | | | |

When doping with phosphoric acid, the elongation increased and the Young's modulus decreased due to the plasticizing effect by phosphoric acid.

As is apparent from the foregoing, according to the present disclosure, an electrolyte membrane for a high-temperature polymer electrolyte membrane fuel cell having a high molecular weight and excellent physical stability and a method of manufacturing the same can be obtained.

According to the present disclosure, an electrolyte membrane for a high-temperature polymer electrolyte membrane fuel cell having good flexibility and excellent thermal stability by virtue of an ether group introduced therein and a method of manufacturing the same can be obtained.

According to the present disclosure, an electrolyte membrane for a high-temperature polymer electrolyte membrane fuel cell with low phosphoric acid leakage and a method of manufacturing the same can be obtained.

According to the present disclosure, an electrolyte membrane for a high-temperature polymer electrolyte membrane fuel cell that is easy to mass produce and a method of manufacturing the same can be obtained.

The effects of the present disclosure are not limited to the foregoing. It should be understood that the effects of the present disclosure include all effects that can be inferred from the description of the present disclosure.

As the test examples and examples of the present disclosure have been described in detail above, the scope of the present disclosure is not limited to the aforementioned test examples and examples, and various modifications and improvements made by those skilled in the art using the basic concept of the present disclosure defined in the following claims are also within the scope of the present disclosure.

What is claimed is:

1. An electrolyte membrane for a high-temperature polymer electrolyte membrane fuel cell, comprising a polymer electrolyte having proton conductivity,
wherein the polymer electrolyte comprises a main chain comprising one or more of fluorene or diphenyl ether and a side chain comprising a nitrogen-including functional group.

2. The electrolyte membrane of claim 1, wherein the nitrogen-including functional group comprises a quaternary ammonium cation.

3. The electrolyte membrane of claim 1, wherein the side chain further comprises a proton conductive functional group connected to the nitrogen-including functional group.

4. The electrolyte membrane of claim 3, wherein the proton conductive functional group comprises a dihydrogen phosphate anion (H₂PO₄⁻).

5. The electrolyte membrane of claim 3, wherein the nitrogen-including functional group and the proton conductive functional group are connected by electrostatic attraction.

6. The electrolyte membrane of claim 1, wherein the polymer electrolyte is represented by Chemical Formula 1 below: 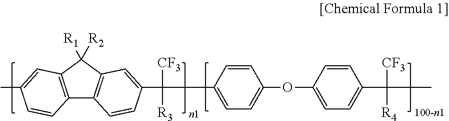
in Chemical Formula 1, each of R₁, R₂, R₃, and R₄ comprises hydrogen, an alkyl group having 1 to 3 carbon atoms, or —(CH₂)ₓ—R₅·H₂PO₄⁻ (where x is a number ranging from 1 to 6),
at least one selected from among R₁, R₂, R₃, and R₄ comprises —(CH₂)ₓ—R₅·H₂PO₄⁻ (where x is a number from 1 to 6),
R₅ comprises —R₆R₇R₈N⁺,
each of R₆, R₇, and R₈ comprises an alkyl group having 1 to 3 carbon atoms; or two thereof are connected to each other to form a ring having 2 to 6 carbon atoms and a remaining one comprises an alkyl group having 1 to 3 carbon atoms, and
n1 is a number ranging from 10 to 90.

7. The electrolyte membrane of claim 6, wherein at least two selected from among R₁, R₂, R₃, and R₄ in Chemical Formula 1 comprise —(CH₂)ₓ—R₅·H₂PO₄⁻ (where x is a number ranging from 1 to 6).

8. The electrolyte membrane of claim 1, wherein the polymer electrolyte is represented by Chemical Formula 2 below: 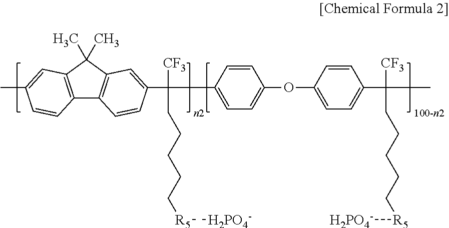
in Chemical Formula 2, R₅ comprises —R₆R₇R₈N⁺,
each of R₆, R₇, and R₈ comprises an alkyl group having 1 to 3 carbon atoms; or two thereof are connected to each other to form a ring having 2 to 6 carbon atoms and a remaining one comprises an alkyl group having 1 to 3 carbon atoms, and
n2 is a number ranging from 10 to 90.

9. The electrolyte membrane of claim 1, wherein the polymer electrolyte has a 5 wt % weight loss temperature of less than 350° C. as measured by thermogravimetric analysis (TGA).

10. The electrolyte membrane of claim 1, wherein the polymer electrolyte has a glass transition temperature of 160° C. or less.

11. The electrolyte membrane of claim 1, wherein the electrolyte membrane has an elongation at break of 80% or more and a Young's modulus of 200 MPa or less.

12. A method of manufacturing an electrolyte membrane for a high-temperature polymer electrolyte membrane fuel cell, comprising:
preparing an intermediate material represented by Chemical Formula 3 below by condensation polymerization of a fluorene monomer and a diphenyl ether monomer in presence of an acid catalyst;
preparing a polymer electrolyte represented by Chemical Formula 4 below by reacting the intermediate material with an amine compound;
manufacturing a thin film using the polymer electrolyte; and
manufacturing an electrolyte membrane by impregnating the thin film with phosphoric acid: 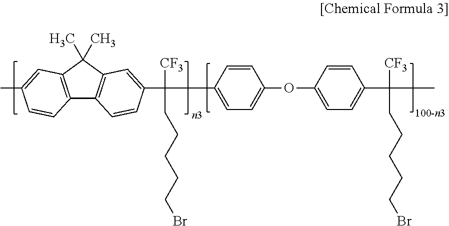
in Chemical Formula 3, n3 is a number ranging from 10 to 90; and 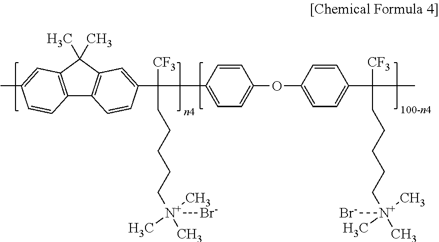
in Chemical Formula 4, n4 is a number ranging from 10 to 90.

13. The method of claim 12, wherein preparing the intermediate material comprises performing the condensation polymerization at 15° C. to 25° C. for 30 minutes or less.

14. The method of claim 12, wherein the polymer electrolyte has a 5 wt % weight loss temperature of less than 350° C. as measured by thermogravimetric analysis (TGA).

15. The method of claim 12, wherein the polymer electrolyte has a glass transition temperature of 160° C. or less.

16. The method of claim 12, wherein the electrolyte membrane has an elongation at break of 80% or more and a Young's modulus of 200 MPa or less.
